(19) United States
(12) Patent Application Publication
(10) Pub. No.: US 2005/0065875 A1
(43) Pub. Date: Mar. 24, 2005

(54) Method and system for credit card purchases

(76) Inventor: Robert E. Beard, Monument, CO (US)

Correspondence Address: PETER F WEINBERG;GIBSON DUNN AND CRUTCHER LLP, SUITE 4100, 1801 CALIFORNIA STREET, DENVER, CO, 80202, US

(21) Appl. No.: 10/983,269

(22) Filed: Nov. 5, 2004

Related U.S. Application Data
(63) Continuation of application No. 10/050,442, filed on Jan. 16, 2002, now abandoned.

(51) Int. Cl. G06F 17/60

(52) U.S. Cl. 705/38

(57) ABSTRACT

A user utilizes a wireless communications device, such as a cellular telephone, capable of establishing a connection with a credit card server located at a credit card service center associated with the issuer of the credit card held by the user. Stored within the wireless communications device is information on the credit card including the credit card number, expiration date, and credit card service center phone number and/or IP address. Utilizing a user interface in the wireless communications device, the user, when presented with a bill, enters the bill amount and the merchant ID number, and optionally a transaction number. The wireless communications device dials up the credit card service center and sends the transaction information. After authentication and approval, the credit card service center debits the user's account, credits the merchant's account, and sends approval messages to the user and the merchant in real time.

### CROSS REFERENCE TO RELATED APPLICATION

This application is a continuation of application Ser. No. 10/050,442, filed on Jan. 16, 2002, titled “Method and System for Credit Card Purchases”, which is incorporated herein by reference in its entirety.

### FIELD OF THE INVENTION

This invention relates to credit card transactions, and more particularly, to a new transaction paradigm for making credit card purchases utilizing wireless technology and devices.

### BRIEF DESCRIPTION OF THE DRAWINGS

FIG. 1 shows a schematic/block diagram of the hardware and communications channels utilized in one embodiment of the present invention.

FIG. 2 shows a block flow diagram of an embodiment of the present invention from a credit card holder perspective.

FIG. 3 shows a block flow diagram of programming a wireless communications device with credit card information in an embodiment of the present invention.

FIG. 4 shows a block flow diagram of an embodiment of the present invention from a credit card service center perspective.

FIG. 5 shows a block flow diagram of an embodiment of the present invention from a merchant financial institution perspective.

FIG. 6 shows a block flow diagram of an embodiment of the present invention from a merchant perspective.

### DETAILED DESCRIPTION OF THE INVENTION

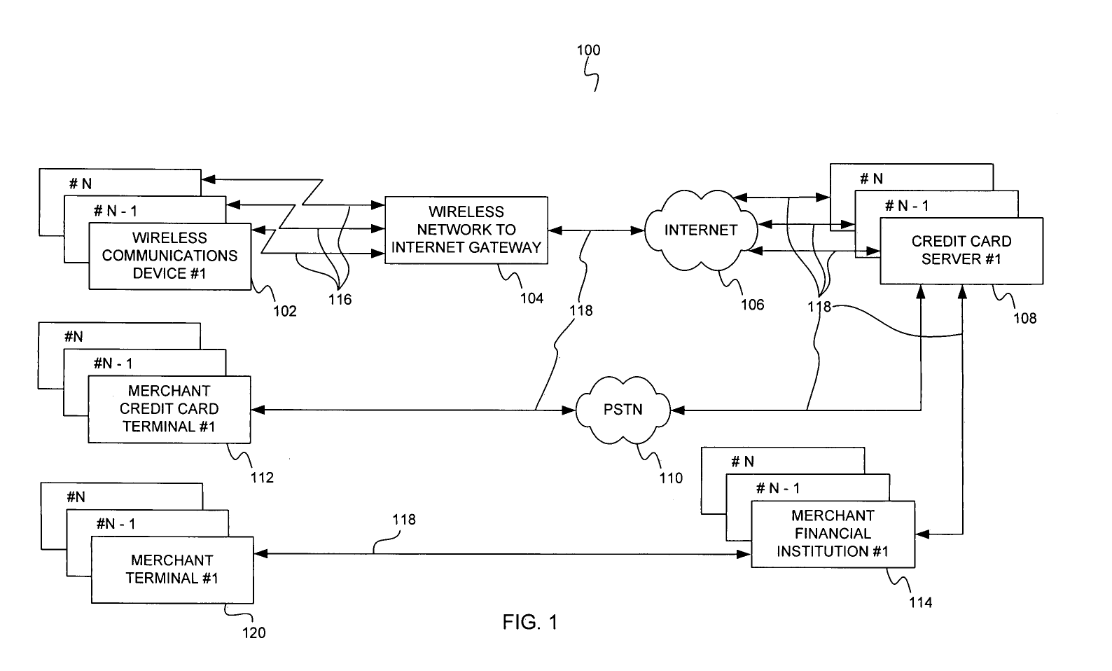

Referring now to the Figures, in which like numerals refer to like portions thereof, FIG. 1 shows a schematic/block diagram of the hardware and communications channels utilized in one embodiment of the present invention. The present invention reduces credit card fraud by eliminating the need for a credit card holder to relinquish control of a credit card, and the information it contains, to another individual, such as a merchant, during a credit card transaction.

Credit card transactions, as they have been executed by past means, have been subject to widespread fraud and abuse. Credit card numbers can be obtained from the paper or carbon copies of credit card slips at the time of the transaction or at a later time when the copies or slips are batched, sorted, or filed, or even when retrieved from the trash. Credit card numbers may be written down by the person who takes the credit card from a credit card holder to process the card through a credit card reader, such as in a restaurant. Once the credit card number is obtained, unscrupulous individuals can use the credit card number to fraudulently charge items to the credit card holder's account.

Prior approaches to solving this fraud problem have been less than satisfactory. Credit card slips may be printed out without the credit card number entirely, or printed out with only a portion of the digits of the credit card number, such as the last four digits, to keep the number confidential. This, however, still does not solve the problem that arises when the credit card holder relinquishes physical control of the credit card to a merchant to be swiped through a credit card reader, or to have the number entered through a keypad, during the credit card transaction process. Even when the credit card holder can visually keep his credit card in sight while it is in the possession of the merchant, this does not prevent the merchant or someone else from seeing and memorizing the credit card number on the credit card during the transaction.

Referring now to FIG. 1, within Hardware/Communications System 100 a credit card holder, also referred to as the “user” in this description of the invention, utilizes a Wireless Communications Device 102 that is capable of connecting to a Credit Card Server 108, typically located at a credit card service center associated with the issuer, or an agent or service provider of the issuer, of the credit card held by the user. A large number of Wireless Communications Devices 102 held by individual users located in diverse geographic locations, as well as Credit Card Servers 108 at multiple credit card service centers in diverse geographic locations, may utilize the present invention.

Wireless Communications Device 102 may be a cellular telephone, a Personal Digital Assistant (“PDA”) having embedded cellular telephone technology and a wireless modem, Personal Communications Services (“PCS”) telephone, or any other comparably equipped communications device, whether it is analog cellular, digital cellular, or other suitable type of wireless service. Wireless Communications Device 102 may also contain other forms of wireless technology such as Bluetooth, 802.11, or IrDa. In utilizing one of these other forms of wireless technology, a user would establish a connection to a local communications gateway (not shown in FIG. 1) provided by the merchant at the merchant's place of business.

From Wireless Communications Device 102 a user initiates a transaction to pay a credit card bill by utilizing the user interface built within Wireless Communications Device 102. The credit card bill is typically presented to the user at a point of service, but the user could also pay a monthly bill, such as a utility bill or other type of obligation payable via credit card, utilizing the present invention.

The user has previously stored the following information in the non-volatile memory of Wireless Communications Device 102: a credit card number; an expiration date of the credit card; a phone number and/or an IP address of the Credit Card Service Center (“CCSC”) for the credit card (which is accessed to deliver the transaction data to the proper Credit Card Server 108); and a pass code or Personal Identification Number (“PIN”) for security purposes. The transaction data and credit card information are sent via Wireless Communications Channel 116 to a Wireless Network To Internet Gateway 104.

Wireless Communications Channel 116 may be General Packet Radio Services (“GPRS”) on a Global System for Mobile Communications (“GSM”) based network. Other wireless transmission systems may also be utilized, such as Frequency Division Multiple Access (“FDMA”), Time Division Multiple Access (“TDMA”), Code Division Multiple Access (“CDMA”), and Cellular Digital Packet Data (“CDPD”). Instead of, or in addition to, a packet based network connection, a properly equipped Wireless Communications Device 102 could use a wireless Short Message Service (“SMS”) available on some cellular networks. The transaction information is relayed from a Short Message Service Center (“SMSC”) (not shown in FIG. 1) at the network operator's facility to the receiving Credit Card Server 108. This would require an interface to the CCSC at the cellular carrier's SMSC. In addition to a wireless packet switched data network, a wireless circuit switched data network could also be utilized with the present invention. Some types of Wireless Communications Devices 102 may support both packet switched and circuit switched data communication.

Wireless Network To Internet Gateway 104 converts the wireless data stream to digital data (if not already in digital form) for transport over Communications Channel 118 to the Internet 106 using Internet Protocol (“IP”) and Secure Sockets Layer (“SSL”). The digital data arrives at Credit Card Server 108, which is a secure server, over Communications Channel 118 at the CCSC. The Credit Card Server 108 authenticates the user and checks the credit card transaction against the user's credit limit, expiration date of the credit card, etc., and sends an approval or denial message back to the user's Wireless Communications Device 102 indicating whether the transaction has been approved or denied. If approved, Credit Card Server 108 sends an approval message via Communications Channel 118 and the Public Switched Telephone Network (“PSTN”) 110 to Merchant Credit Card Terminal 112, which is typically a credit card reader of some type, which prints out an approval slip. Verifone credit card terminals in wide use today may have both PSTN and CDPD interfaces. Credit Card Server 108 then sends a credit transaction via Communications Channel 118 to Merchant Financial Institution 114, and debits the user's account. A large number of Merchant Data Terminals 112 located at a large number of different merchants in diverse geographic locations, as well as Merchant Financial Institutions 114 in diverse geographic locations, may utilize the present invention.

The merchant may also have a terminal or other device, such as Merchant Terminal 120 connected to Merchant Financial Institution 114 via Communications Channel 118 (or through PSTN 110 and/or the Internet 106) that would also allow the merchant to verify the deposit of funds from the user at the time of the transaction. The credit card transaction typically occurs in real time. In an alternative embodiment of the invention, actual fund transfers are settled at a later time, such as once a day, with the merchant being guaranteed at the time of the transaction that the transaction is authorized and that funds will be transferred at the specified time.

One skilled in the art will recognize that the present invention thus modifies the fundamental process used today during credit card transactions. Instead of a “pull” type process, where a merchant receives credit card information that essentially authorizes the merchant to pull money out of the user's account to settle the transaction, the present invention allows the transaction to be settled by the user depositing money directly into the merchant's account. In this new paradigm the user actually “pushes” the funds to the merchant account, instead of the merchant “pulling” funds from the user's account.

In addition, the present invention utilizes the existing financial institutions and infrastructures currently utilized for credit card transactions, including the current credit card readers merchants utilize. Only modifications to the programming of the Wireless Communications Device 102 are required to support the credit card transaction processing and the credit card information storage. In an alternative embodiment of the invention, Wireless Communications Devices 102 utilizing GSM cellular networks that support Subscriber Information Module (“SIM”) Toolkit can be remotely programmed by the network operator to support credit card transaction processing and credit card information storage.

One skilled in the art will also recognize that the present invention allows a user to never have to show or relinquish physical control of the credit cards held. In fact, the user, after programming Wireless Communications Device 102, need not even carry the credit cards at all. The merchant never sees the credit card and never knows the credit card number. Thus, the present invention eliminates the fraud problem associated with traditional credit card purchases.

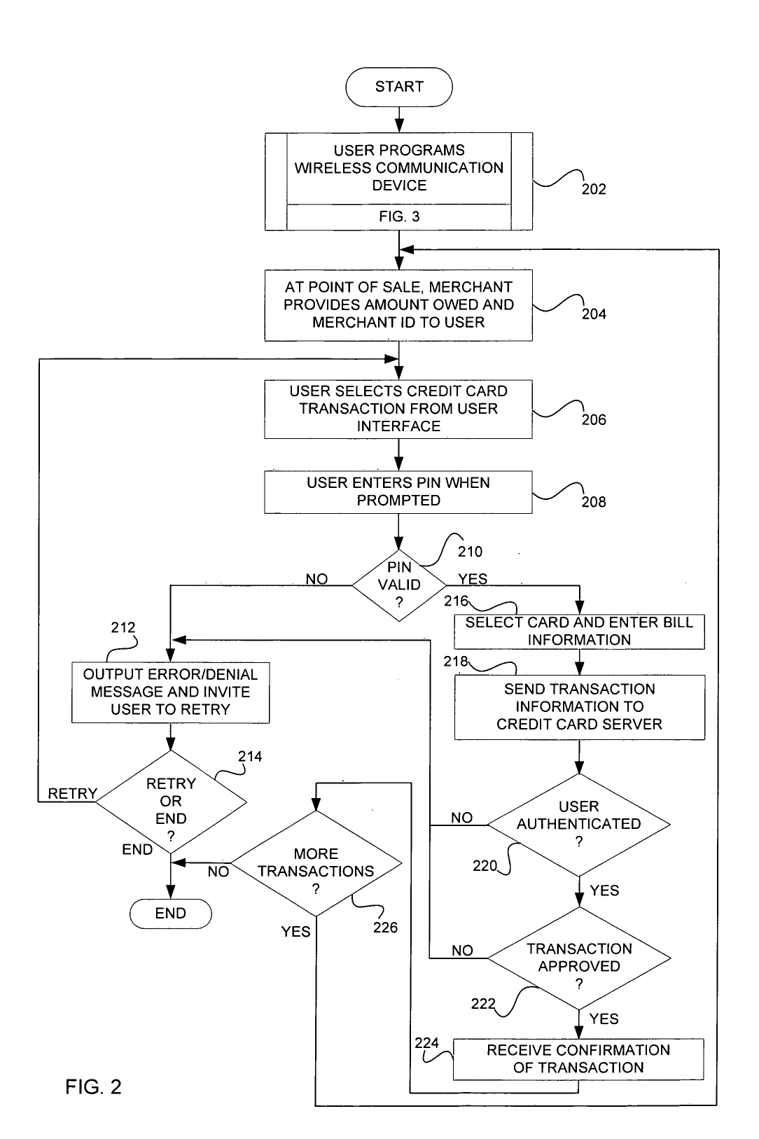

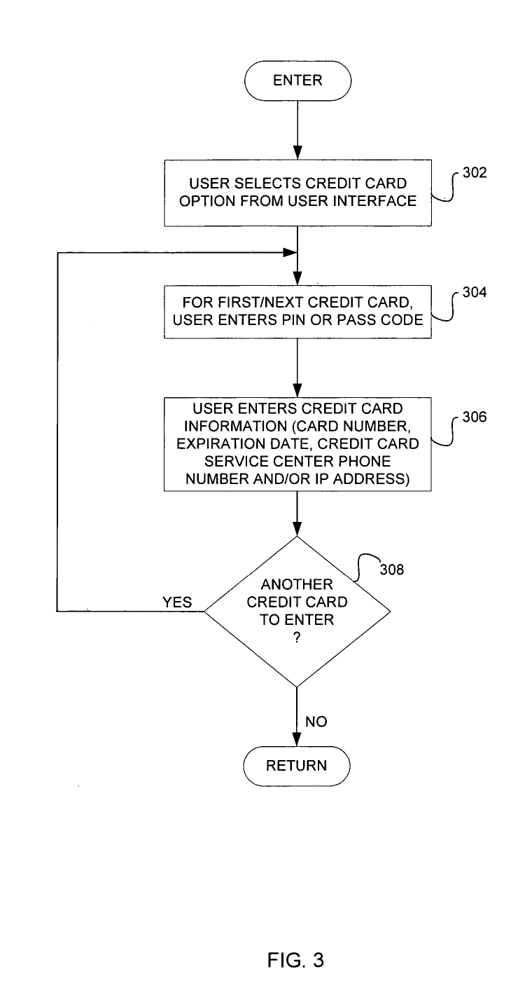

FIG. 2 shows a block flow diagram of an embodiment of the present invention from a user perspective. Referring now to FIG. 2, the method begins in step 202, which calls FIG. 3, in which the user enters information for his credit card(s) into Wireless Communications Device 102 (discussed below).

Upon returning from FIG. 3, in step 204, the user is presented with a bill from a merchant at a point of sale, such as a store, restaurant, gas station, etc. In step 206 the user initiates a credit card transaction protocol through the user interface of Wireless Communications Device 102. In step 208, after being prompted through the user interface for a PIN or pass code, the user enters through the user interface the security code set up in step 304 (FIG. 3). Step 210 determines if the security code entered in step 208 is valid. This step prevents the fraudulent use of the credit card information should Wireless Communications Device 102 be lost or stolen. If step 210 determines that the security code is invalid, then in step 212 the user interface outputs an error message and prompts the user to try again. This may be through a visual display on Wireless Communications Device 102 (e.g., “DENIED—<Invalid PIN>”), an audible sound or actual speech, flashing light, etc. Step 214 determines if the user has opted to retry to enter the security code, or has opted to end. Retry returns control to step 206. Otherwise, the method ends.

If step 210 determines that the security code entered is valid, then in step 216 the user selects a particular credit card if one or more credit cards previously entered into memory are associated with the valid PIN. A list of credit cards to choose from are presented to the user through the user interface. If only one credit card is associated with the valid PIN, that credit card is automatically selected for this transaction. The user then enters through the user interface of Wireless Communications Device 102 the bill information, which includes the dollar amount of the purchase and the merchant identification (“ID”) number. In situations where tipping is customary, the user may enter a dollar amount that is above the amount of the purchase for the tip. Alternatively, two amounts may be entered by the user, one amount for the amount of the purchase, and a second amount for the amount of the tip. The two amounts may be totaled by the programming within Wireless Communications Device 102 prior to transmission, or totaled when received in Credit Card Server 108. The merchant ID number is given by merchant banks to anyone who bills credit cards. They are typically eight to sixteen digits, depending upon the issuing merchant bank.

In step 218 the transaction information, which includes the bill information plus the credit card information, is transmitted to Credit Card Server 108. This may occur automatically after the user has entered in the required information, or the user may through the user interface select is a send option to transmit the transaction information. The transaction information may also include a transaction number in order to distinguish this particular transaction from any other similar transactions occurring at relatively the same time at the merchant's location. The software code embedded in Wireless Communications Device 102 utilizes the phone number or the IP address of the CCSC associated with the selected card and sends the transaction information to Credit Card Server 108.

Step 220 authenticates the user's identification. In addition to evaluating the information received, authentication may require the user to enter another security code through the user interface of Wireless Communications Device 102. If the user identification is not authenticated in step 220, then in step 212 the user interface of Wireless Communications Device 102 outputs an error message to the user (e.g., “DENIED—<Invalid PIN>”) and prompts the user to try again.

If the user identification is authenticated in step 220, then in step 222 the transaction is evaluated for approval. If the transaction is not approved, then in step 212 the user interface of Wireless Communications Device 102 outputs an error message to the user, in this case a denial message (e.g., “DENIED<Purchase Exceeds Credit Limit>, <Unknown Merchant ID Number>, <Credit Card Expired>,” etc.) and prompts the user to try again with a different credit card. If the transaction is approved in step 222, then in step 224 the user receives a confirmation message (“APPROVED—<approval code>”). Step 226 determines if there are more transactions at this time. If yes, control returns to step 204. Otherwise, the method ends.

In an alternative embodiment of the invention, for a Wireless Communications Device 102 equipped with a Smart Card slot, the Smart Card information does not have to be loaded into the non-volatile memory of Wireless Communications Device 102. At a point of sale, the user inserts the Smart Card in the slot, enters the dollar amount of the purchase, and enters the merchant ID number through the user interface of Wireless Communications Device 102. Wireless Communications Device 102 then contacts the CCSC from information derived from the data stored in the Smart Card. The rest of the steps outlined above would then be the same. As an additional security measure, each Smart Card could be locked to the Electronic ID (“EID”) or the manufacturer's serial number (“MSN”) of Wireless Communications Device 102.

FIG. 3 shows a block flow diagram of programming a wireless communications device with credit card information in an embodiment of the present invention. Referring now to FIG. 3, utilizing a user interface within Wireless Communications Device 102, a user selects the set up credit card option from the user interface in step 302. The user interface of Wireless Communications Device 102 may consist of software code programmed within Wireless Communications Device 102 which controls a keypad or other type of input/output modality.

In step 304, for a first credit card, the user in response to a prompt from the user interface enters a security code, such as a PIN or pass code, to be associated with the first credit card. A PIN typically has numeric digits only, whereas a pass code may be a combination of alphanumeric characters. A PDA may be more conducive to having alphanumeric characters as opposed to a cellular telephone.

In step 306, in response to prompts from the user interface, the user enters the credit card information, which may include the credit card number, the expiration date of the credit card number, and the phone number and/or IP address of the CCSC for this credit card number. All of this information is stored in the non-volatile memory of Wireless Communications Device 102. In another embodiment of the invention, for a Wireless Communications Device 102 equipped with a Smart Card slot, the user could load the credit card number, expiration date, and the phone number and/or IP address of the CCSC by inserting the Smart Card in the Smart Card slot. The information in the Smart Card is then automatically read and stored in the non-volatile memory of Wireless Communications Device 102.

Step 308 determines if the user has more credit cards to enter into memory. If yes, control returns to step 304. The user may use the same security code for each credit card, or establish a different security code for each credit card. If in step 308 there are no more credit cards to enter into memory, then control returns to step 204 of FIG. 2.

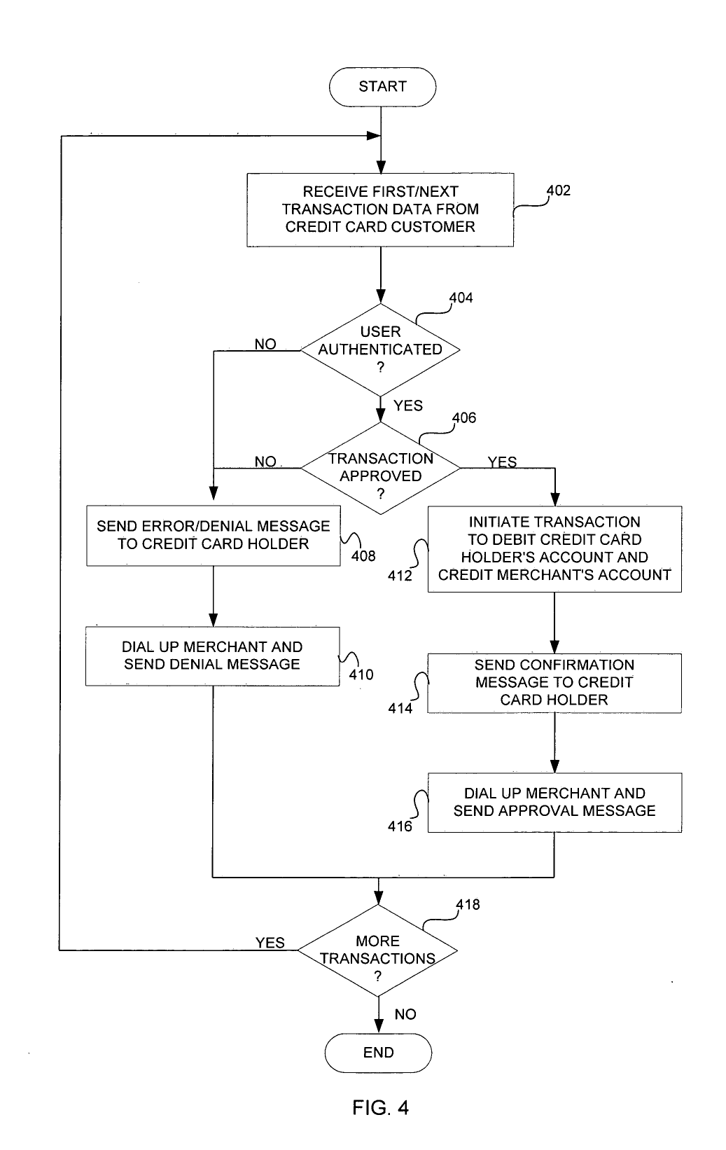

FIG. 4 shows a block flow diagram of an embodiment of the present invention from a credit card service center perspective. Referring now to FIG. 4, the method begins in step 402 when Credit Card Server 108 at the CCSC receives transaction information from a user's Wireless Communications Device 102. Step 404 authenticates the credit card holder's identification. This may be accomplished by comparing the pertinent information received against the records of valid credit card holders maintained by the credit card service center. If the user identification fails authentication, then in step 408 an error message is sent to the credit card holder's Wireless Communications Device 102 and in step 410 Credit Card Server 108 dials the number of Merchant Credit Card Terminal 112, derived from the merchant ID number, and sends a denial message. Based upon a predetermined pattern or number of consecutive authentication failures, which may be associated with an unauthorized individual attempting to utilize the user's Wireless Communications Device 102, an alert may be generated by Credit Card Server 108 that Wireless Communications Device 102 may have been lost or stolen from its rightful owner.

If the user identification passes authentication in step 404, then in step 406 the transaction information is evaluated for approval against the status of the credit card holder's account. The amount presented in the transaction is checked against the credit limit of the credit card holder's account. The expiration date of the credit card is checked. The merchant ID number is checked against a list of established Merchant IDs. If the transaction is not approved for any of these reasons, then in step 408 a denial message is sent to the credit card holder's Wireless Communications Device 102 which is output through the user interface to the credit card holder. In step 410 Credit Card Server 108 dials the number of Merchant Credit Card Terminal 112 and sends a denial message.

If the transaction is approved in step 406, then in step 412 Credit Card Server 108 transmits in real time a debit transaction to debit the credit card holder's account and transmits in real time a credit transaction to credit the merchant's account at Merchant Financial Institution 114, which may be a bank or other type of financial institution. In step 414 Credit Card Server 108 sends a confirmation message to the credit card holder's Wireless Communications Device 102. In step 416 Credit Card Server 108 dials up Merchant Credit Card Terminal 112 and transmits an approval message.

Step 418 determines if there are more transactions to process. If yes, control returns to step 402. Otherwise, the method ends.

In an alternative embodiment of the invention, when the user is paying a bill via credit card but not at a point of service where a Merchant Terminal 120 is utilized, such as paying a monthly utility bill, step 410 would not be performed if the transaction was not approved. Similarly, step 416 would not be performed if the transaction was approved. In this embodiment of the invention, the user must have prior knowledge of, and the utility company must also have, a merchant ID.

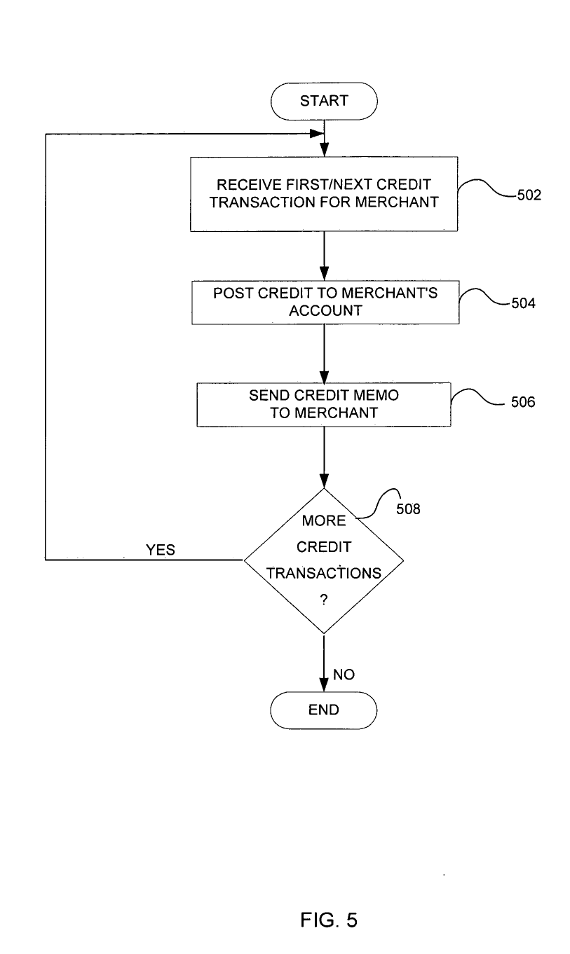

FIG. 5 shows a block flow diagram of an embodiment of the present invention from a merchant financial institution perspective. Referring now to FIG. 5, the method begins is step 502 when Merchant Financial Institution 114 receives the credit transaction from Credit Card Server 108. Merchant Financial Institution 114 posts the credit to the merchant's account in step 504. Merchant Financial Institution 114 then sends a credit memo to the merchant in step 506. The receiving of the credit transaction, posting of the credit, and the sending of the credit memo may be done in real time such that the merchant may verify the deposit of funds from the credit card holder at the time of the transaction utilizing Merchant Terminal 120 connected to Merchant Financial Institution 114. If it is determined in step 508 that there are more credit transactions, then control returns to step 502. Otherwise, the method ends.

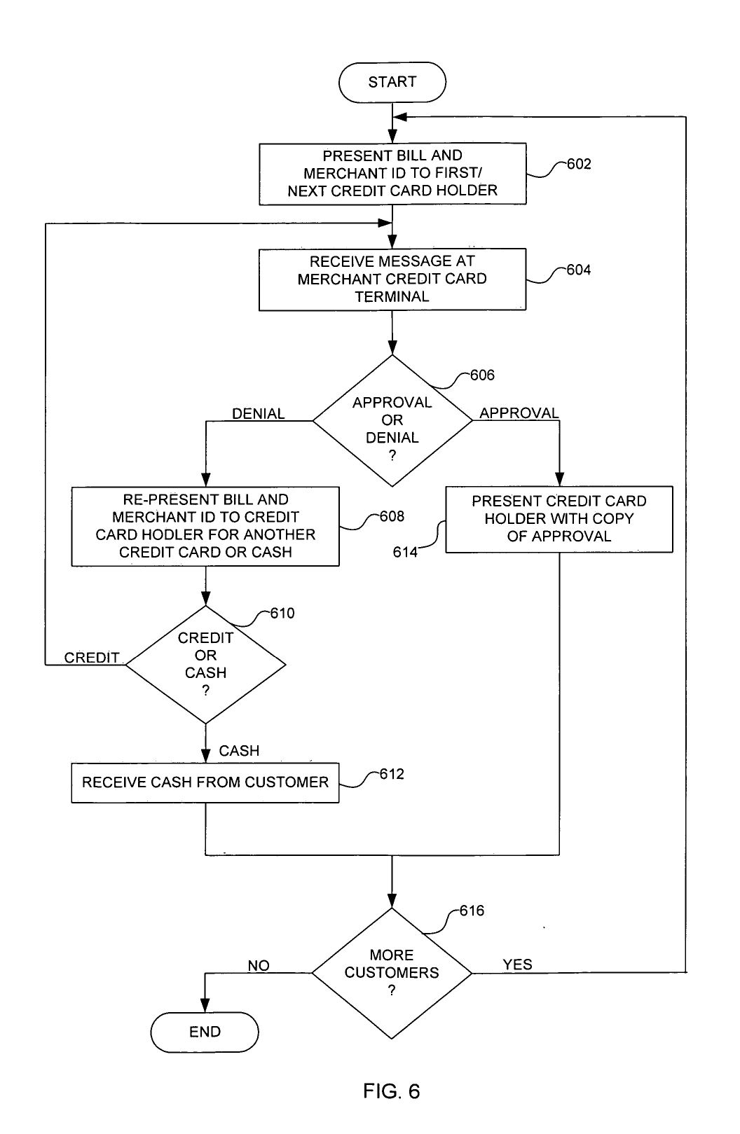

FIG. 6 shows a block flow diagram of an embodiment of the present invention from a merchant perspective. Referring now to FIG. 6, the method begins in step 602 when the merchant presents the bill and its merchant ID number to the user. The merchant may also present a transaction number to the user. After the user utilizes Wireless Communications Device 102 to initiate the transaction, the merchant in step 604 receives a message at Merchant Credit Card Terminal 112 from Credit Card Server 108. A credit memo may also be received at Merchant Terminal 120 from Merchant Financial Institution 114. If step 606 determines that an approval message is received from Credit Card Server 108, then in step 614 the merchant presents the user with a copy of the approval message generated at Merchant Credit Card Terminal 112. The approval message may include, but is not limited to, the total dollar amount approved, the amount of the purchase, the tip amount, if any, the name of the credit card service center, the date, the time, the merchant ID, the transaction number, etc. Step 616 determines if there are more users for the merchant to present bills. If yes, control returns to step 602. Otherwise, the method ends.

If step 606 determines that a denial message is received, then in step 608 the merchant presents a copy of the denial message generated at Merchant Credit Card Terminal 112 and represents the bill and merchant ID number to the user to try another credit card or to pay cash. The denial message may include, but is not limited to, the total dollar amount not approved, the amount of the purchase, the tip amount, if any, the name of the credit card service center, the date, the time, the merchant ID, the transaction number, etc. If the user wants to try another credit card, then control returns to step 604. If the user decides to pay cash, then in step 612 the merchant receives the cash from the user. Step 616 determines if there are more customers for the merchant to present bills. If yes, control returns to step 602. Otherwise, the method ends.

Having described the present invention, it will be understood by those skilled in the art that many and widely differing embodiments and applications of the invention will suggest themselves without departing from the scope of the present invention.

1. A method for making a credit card purchase between a user and a merchant, the method comprising:
(a) selecting by the user a credit card transaction protocol through a user interface of a wireless communications device;
(b) entering by the user a bill information through said user interface of said wireless communications device;
(c) transmitting said bill information, and a first credit card information pertaining to a first credit card, from said wireless communications device to a credit card server maintained by an issuer of said first credit card; and
(d) receiving, if the credit card purchase is approved by said credit card server, a confirmation message from said credit card server in said wireless communications device and output through said user interface to the user.

2. A method according to claim 1 further comprising:
selecting by the user a set up credit card option through said user interface of said wireless communications device;
entering by the user a first security code for storage in a non-volatile memory of said wireless communications device; and
entering by the user said first credit card information for said first credit card to be associated with said first security code for storage in said non-volatile memory of said wireless communications device.

3. A method according to claim 2 further comprising:
entering by the user a second credit card information pertaining to a second credit card to be associated with said first security code for storage in said non-volatile memory of said wireless communications device; and
repeating said previous entering step for a next credit card information pertaining to a next credit card to be associated with said first security code for storage in said non-volatile memory of said wireless communications device.

4. A method according to claim 2 further comprising:
entering by the user a second security code for storage in said non-volatile memory of said wireless communications device;
entering by the user a second credit card information pertaining to a second credit card to be associated with said second security code for storage in said non-volatile memory of said wireless communications device; and
repeating said previous two entering steps for a next security code and a next credit card information pertaining to a next credit card to be associated with said next security code for storage in said non-volatile memory of said wireless communications device.

5. A method according to claim 2 wherein said first credit card information pertaining to said first credit card is at least a one of a credit card number, an expiration date of said first credit card, a phone number of a credit card service center housing said credit card server for said first credit card, and an IP address of said credit card server housed at said credit card service center for said first credit card.

6. A method according to claim 1 wherein said entering step further comprises:
receiving by the user from the merchant said bill information, which is at least a one of a dollar amount owed, a merchant ID number, and a transaction number.

7. A method according to claim 1 wherein said transmitting and receiving steps are performed in real time.

8. A method according to claim 1 wherein said entering step further comprises:
entering a security code to gain access to said credit card transaction protocol.

9. A method according to claim 1 wherein said entering step further comprises:
entering at least a one of a merchant ID number, a dollar amount, and a transaction number through said user interface.

10. A method according to claim 1 further comprising:
selecting by the user through said user interface said first credit card from a plurality of credit cards stored in a non-volatile memory of said wireless communications device, wherein said first credit card information pertaining to said first credit card is used for the credit card purchase.

11. A method according to claim 1 further comprising:
receiving, when the credit card purchase is not approved by said credit card server, an error message from said credit card server in said wireless communications device and output through said user interface to the user.

12. A method according to claim 11 wherein said receiving of said error message is performed in real time.

13. A method according to claim 1 further comprising:
entering by the user through said user interface of said wireless communications device a security code; and
transmitting said security code to said credit card server for authentication purposes.

14. A method for processing in a credit card server a credit card transaction between a merchant and a user having a wireless communications device, wherein the credit card server is maintained by an issuer of a credit card issued to the user, the method comprising:
(a) receiving in the credit card server a first transaction information from the wireless communications device of the user, wherein said first transaction information comprises a first bill information and a first credit card information;
(b) authenticating by the credit card server said first credit card information;
(c) evaluating by the credit card server said first transaction information for approval against a status of an account of the user; and
(d) if said first transaction information is approved,
(d1) transmitting by the credit card server a debit transaction to debit said account of the user; and
(d2) transmitting by the credit card server a credit transaction to credit an account of the merchant at a merchant financial institution.

15. A method according to claim 14 wherein step (d) further comprises the step (d3):
(d3) transmitting by the credit card server an approval message to a merchant credit card terminal of the merchant.

16. A method according to claim 15 wherein steps (d1), (d2), and (d3) are performed in real time.

17. A method according to claim 14 wherein step (d) further comprises:
(d4) transmitting by the credit card server a confirmation message to the wireless communications device of the user.

18. A method according to claim 14 wherein step (d4) is performed in real time.

19. A method according to claim 14 further comprising:
when said first credit card information is not authenticated,
transmitting by the credit card server a first denial message to the wireless communications device of the user.

20. A method according to claim 19 further comprising:
transmitting by the credit card server a second denial message to a merchant credit card terminal of the merchant.

21. A method according to claim 20 wherein said transmitting of said first denial message and said transmitting of said second denial message is performed in real time.

22. A method according to claim 14 further comprising:
when said first transaction information is not approved,
transmitting by the credit card server a first denial message to a merchant credit card terminal of the merchant.

23. A method according to claim 22 further comprising:
transmitting by the credit card server a second denial message to the wireless communications device of the user.

24. A method according to claim 23 wherein said transmitting of said first denial message and said transmitting of said second denial message is performed in real time.

25. A method according to claim 14 wherein step (b) further comprises:
transmitting by the credit card server a request for a security code to the wireless communications device; and
receiving in the credit card server a security code from the wireless communications device.

26. A method according to claim 25 wherein said transmitting of said request for a security code and said receiving said security code is performed in real time.

27. A method for processing in a merchant financial institution a credit transaction generated as a result of a credit card transaction between a merchant, who has an account at the merchant financial institution, and a user having a wireless communications device, the method comprising:
(a) receiving the credit transaction from a credit card server, wherein said credit card server is maintained by an issuer of a credit card issued to the user, and further wherein said credit card server has received a first transaction information for the credit card transaction from the wireless communications device of the user and has authenticated and approved said first transaction information;
(b) posting, by the merchant financial institution, a credit to the account of the merchant at the merchant financial institution for a dollar amount derived from the credit transaction; and
(c) sending, by the merchant financial institution, a credit memo to a merchant terminal of the merchant in communication with the merchant financial institution.

28. A method according to claim 27 wherein steps (a), (b), and (c) are performed in real time.

29. A method according to claim 27 wherein said first transaction information further comprises a first bill information and a first credit card information.

30. A method according to claim 29 wherein said credit card server identifies the merchant financial institution through a merchant ID number contained in said first bill information, said first bill information also having at least a one of said dollar amount of the credit card transaction and a transaction number.

31. A method for making a credit card purchase between a user and a merchant, the method comprising:
(a) presenting, by the merchant, at least a one of a dollar amount owed, a merchant ID number, and a transaction number to the user, wherein the user has a wireless communications device for entering and transmitting said at least a one of said dollar amount owed, said merchant ID number, and said transaction number to a credit card server, wherein said credit card server is maintained by an issuer of a credit card number issued to the user;
(b) receiving by the merchant, if the credit card purchase is approved by said credit card server, an approval message in a merchant credit card terminal from said credit card server; and
(c) presenting, by the merchant, a copy of said approval message to the user.

32. A method according to claim 31 wherein step (b) is performed in real time.

33. A method according to claim 31 further comprising:
receiving, when the credit card purchase is not approved by said credit card server, a denial message in said merchant credit card terminal from said credit card server;
presenting the user with a copy of said denial message; and
representing, by the merchant, said dollar amount owed and said merchant ID number to the user.

34. A method according to claim 33 wherein said receiving of said denial message is performed in real time.

35. A method according to claim 31 wherein the user transmits from said wireless communications device, along with said at least a one of said dollar amount owed, said merchant ID number, and said transaction number, a first credit card information to said credit card server.

36. A method according to claim 35 wherein said first credit card information further comprises at least a one of said credit card number, an expiration date of said credit card number, a phone number of a credit card service center housing said credit card server for said credit card number, and an IP address of said credit card server housed at said credit card service center for said first credit card.

37. A system for making a credit card purchase between a user and a merchant, the system comprising:
a wireless communications device, said wireless communications device further comprising,
a user interface;
a credit card transaction protocol accessible through said user interface;
a non-volatile memory; and
at least one credit card information pertaining to
at least one credit card stored in said non-volatile memory; and
at least one credit card server connectable to said wireless communications device and maintained by an issuer of said at least one credit card,
wherein the user enters a bill information for the credit card purchase through said user interface of said wireless communications device, and transmits said bill information and said at least one credit card information to said at least one credit card server, and
further wherein said at least one credit card server receives and evaluates said bill information and said at least one credit card information transmitted from said wireless communications device, and
if the credit card purchase is approved, said at least one credit card server sends a confirmation message to said wireless communications device, which is output through said user interface to the user.

38. The system according to claim 37 wherein if the credit card purchase is not approved, said at least one credit card server sends a first denial message to said wireless communications device, which is output through said user interface to the user.

39. The system according to claim 37 further comprising:
at least one merchant credit card terminal connectable to said at least one credit card server,
wherein if the credit card purchase is approved, said at least one credit card server sends an approval message to said at least one merchant credit card terminal.

40. The system according to claim 39 wherein said wireless communications device, said at least one credit card server, and said at least one merchant credit card terminal perform the credit card purchase in real time.

41. The system according to claim 39 wherein if the credit card purchase is not approved, said at least one credit card server sends a second denial message to said at least one merchant credit card terminal.

42. The system according to claim 37 wherein said wireless communications device further comprises:
a set up credit card option accessible through said user interface of said wireless communications device,
wherein the user enters at least one security code for storage in said non-volatile memory of said wireless communications device, and
further wherein the user enters said at least one credit card information for said at least one credit card to be associated with said at least one security code for storage in said non-volatile memory of said wireless communications device, wherein the user enters said at least one security code to access said credit card transaction protocol to make the credit card purchase.

43. The system according to claim 37 wherein said at least one credit card information pertaining to said at least one credit card further comprises at least a one of a credit card number, an expiration date of said at least one credit card, a phone number of at least one credit card service center housing said at least one credit card server for said at least one credit card, and an IP address of said at least one credit card server housed at said at least one credit card service center for said at least one credit card.

44. The system according to claim 37 wherein said bill information further comprises at least a one of a dollar amount owed, a merchant ID number, and a transaction number.

45. The system according to claim 37 further comprising:
at least one merchant financial institution connectable to said at least one credit card server, wherein if the credit card purchase is approved, said at least one credit card server transmits a debit transaction to debit an account of the user, and transmits a credit transaction to credit an account of the merchant at said at least one merchant financial institution.

46. The system according to claim 45 wherein said at least one merchant financial institution posts a credit to the account of the merchant at the merchant financial institution for a dollar amount derived from said credit transaction, and sends a credit memo to a merchant terminal of the merchant in communication with the merchant financial institution.

47. The system according to claim 37 further comprising:
a wireless network to internet gateway; and
a wireless communications channel,
wherein said wireless network to internet gateway receives said transmissions from said wireless communications device over said wireless communications channel and converts said transmissions to digital data for transport over a communications channel to said at least one credit card server.

48. The system according to claim 37 wherein said wireless communications channel is at least a one of a wireless packet switched data network, a wireless short message service, and a wireless circuit switched data network.

49. The system according to claim 37 wherein said wireless communications device is at least a one of a cellular telephone, a personal digital assistant, and a personal communications services telephone that utilizes at least a one of analog cellular wireless service and digital cellular wireless service.

50. A method for making a credit card purchase between a user and a merchant, the method comprising:
(a) selecting by the user a credit card transaction protocol through a user interface of a wireless communications device;
(b) entering by the user a bill information through said user interface of said wireless communications device;
(c) transmitting said bill information, and a first credit card information pertaining to a first credit card, from said wireless communications device to a credit card server maintained by an issuer of said first credit card;
(d) authenticating by said credit card server said first credit card information;
(e) evaluating by said credit card server said first bill information for approval against a status of an account of the user; and
(f) if said first credit card information is authenticated and said first bill information is approved,
(f1) transmitting by said credit card server a debit transaction to debit said account of the user; and
(f2) transmitting by said credit card server a credit transaction to credit an account of the merchant at a merchant financial institution.

51. A method according to claim 50 wherein step (f) further comprises the step (f3):
(f3) transmitting by said credit card server an approval message to a merchant credit card terminal of the merchant.

52. A method according to claim 51 further comprising:
when said first credit card information is not authenticated,
transmitting in real time by said credit card server a first denial message to said merchant credit card terminal of the merchant.

53. A method according to claim 51 further comprising:
when said first transaction information is not approved,
transmitting in real time by said credit card server a second denial message to said merchant credit card terminal of the merchant.

54. A method according to claim 50 wherein step (f) further comprises the step (f3):
(f3) transmitting in real time by said credit card server a confirmation message to said wireless communications device, which is output through said user interface to the user.

55. A method according to claim 50 further comprising:
selecting by the user a set up credit card option through said user interface of said wireless communications device;
entering by the user a first security code for storage in a non-volatile memory of said wireless communications device; and
entering by the user said first credit card information for said first credit card to be associated with said first security code for storage in said non-volatile memory of said wireless communications device.

56. A method according to claim 55 further comprising:
entering by the user a second credit card information pertaining to a second credit card to be associated with said first security code for storage in said non-volatile memory of said wireless communications device; and
repeating said previous entering step for a next credit card information pertaining to a next credit card to be associated with said first security code for storage in said non-volatile memory of said wireless communications device.

57. A method according to claim 55 further comprising:
entering by the user a second security code for storage in said non-volatile memory of said wireless communications device;
entering by the user a second credit card information pertaining to a second credit card to be associated with said second security code for storage in said non-volatile memory of said wireless communications device; and
repeating said previous two entering steps for a next security code and a next credit card information pertaining to a next credit card to be associated with said next security code for storage in said non-volatile memory of said wireless communications device.

58. A method according to claim 50 wherein said first credit card information pertaining to said first credit card is at least a one of a credit card number, an expiration date of said first credit card, a phone number of a credit card service center housing said credit card server for said first credit card, and an IP address of said credit card server housed at said credit card service center for said first credit card.

59. A method according to claim 50 wherein said entering step further comprises:
receiving by the user from the merchant said bill information, which is at least a one of a dollar amount owed, a merchant ID number, and a transaction number.

60. A method according to claim 50 wherein said transmitting steps are performed in real time.

61. A method according to claim 50 wherein said entering step further comprises:
entering a security code to gain access to said credit card transaction protocol.

62. A method according to claim 50 wherein said entering step further comprises:
entering at least a one of a merchant ID number, a dollar amount, and a transaction number through said user interface.

63. A method according to claim 50 further comprising:
selecting by the user through said user interface said first credit card from a plurality of credit cards stored in a non-volatile memory of said wireless communications device, wherein said first credit card information pertaining to said first credit card is used for the credit card purchase.

64. A method according to claim 50 further comprising:
when said first credit card information is not authenticated,
transmitting in real time by said credit card server a first denial message to said wireless communications device of the user.

65. A method according to claim 50 further comprising:
when said first transaction information is not approved,
transmitting in real time by said credit card server a second denial message to said wireless communications device of the user.

66. A method according to claim 50 further comprising:
entering by the user through said user interface of said wireless communications device a security code; and
transmitting said security code to said credit card server for authentication purposes.

67. A method according to claim 50 further comprising:
posting by said merchant financial institution a credit to said account of the merchant at said merchant financial institution for a dollar amount derived from said credit transaction; and
sending by said merchant financial institution a credit memo to a merchant terminal of the merchant in communication with said merchant financial institution.

68. A method according to claim 50 wherein said credit card server identifies said merchant financial institution through a merchant ID number contained in said first bill information.

69. A method according to claim 50 further comprising:
presenting, by the merchant, at least a one of a dollar amount owed, a merchant ID number, and a transaction number to the user; and
presenting, by the merchant, a copy of said approval message to the user.
